(19) United States
(12) Patent Application Publication
(10) Pub. No.: US 2026/0219411 A1
(43) Pub. Date: Jul. 30, 2026

(54) FIELD OPERATIONS FRAMEWORK

(71) Applicant: SCHLUMBERGER TECHNOLOGY CORPORATION, Sugar Land, TX (US)

(72) Inventors: Sarah Hesham BADR, Muscat (OM); Abdurraouf Abdullah AL-JABER, Dhahran (SA); Valerian GUILLOT, Montpellier (FR); Sachit SAUMYA, Clamart (FR); Florian KARPFINGER, Petaling Jaya (MY); Mahmoud YASSIN, Montpellier (FR)

(21) Appl. No.: 19/142,643

(22) PCT Filed: Jun. 4, 2024
(86) PCT No.: PCT/US2024/032419

§ 371 Date: Jun. 24, 2025

Related U.S. Application Data
(60) Provisional application No. 63/471,050, filed on Jun. 5, 2023.

(51) Int. Cl. G01V 1/50; G06N 20/00

(52) U.S. Cl. CPC G01V 1/50; G06N 20/00

(57) ABSTRACT

A method can include receiving log data for different types of logs; identifying a portion of the log data that corresponds to a type of formation; defining combinations of the portion of the log data that correspond to the type of formation; implementing a machine learning model that generates scores for the combinations, where each of the scores indicates an ability of each of the combinations to predict one or more target logs therein as selected from the different types of logs; and outputting, based on a ranking of the scores, at least a top ranked one of the combinations that corresponds to the type of formation.

### RELATED APPLICATIONS

This application claims priority to and the benefit of a US Provisional Application having Ser. No. 63/471,050, filed 5 Jun. 2023, which is incorporated by reference herein in its entirety.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.). Various operations may be performed in the field to access such hydrocarbon fluids and/or produce such hydrocarbon fluids. For example, consider equipment operations where equipment may be controlled to perform one or more operations (e.g., logging, drilling, etc.). In such an example, control may be based at least in part on characteristics of rock where drilling into such rock forms a borehole that can be completed to form a well to produce from a reservoir and/or to inject fluid into a reservoir. While hydrocarbon fluid reservoirs are mentioned as an example, a reservoir that includes water and brine may be assessed, for example, for one or more purposes such as, for example, carbon storage (e.g., sequestration), water production or storage, geothermal production or storage, metallic extraction from brine, etc.

### SUMMARY

A method can include receiving log data for different types of logs; identifying a portion of the log data that corresponds to a type of formation; defining combinations of the portion of the log data that correspond to the type of formation; implementing a machine learning model that generates scores for the combinations, where each of the scores indicates an ability of each of the combinations to predict one or more target logs therein as selected from the different types of logs; and outputting, based on a ranking of the scores, at least a top ranked one of the combinations that corresponds to the type of formation. A system can include one or more processors; memory accessible to at least one of the one or more processors; processor-executable instructions stored in the memory and executable to instruct the system to: receive log data for different types of logs; identify a portion of the log data that corresponds to a type of formation; define combinations of the portion of the log data that correspond to the type of formation; implement a machine learning model that generates scores for the combinations, where each of the scores indicates an ability of each of the combinations to predict one or more target logs therein as selected from the different types of logs; and output, based on a ranking of the scores, at least a top ranked one of the combinations that corresponds to the type of formation. One or more computer-readable storage media can include processor-executable instructions to instruct a computing system to: receive log data for different types of logs; identify a portion of the log data that corresponds to a type of formation; define combinations of the portion of the log data that correspond to the type of formation; implement a machine learning model that generates scores for the combinations, where each of the scores indicates an ability of each of the combinations to predict one or more target logs therein as selected from the different types of logs; and output, based on a ranking of the scores, at least a top ranked one of the combinations that corresponds to the type of formation. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates an example of a system;

FIG. 3 illustrates an example of a drilling equipment and examples of borehole shapes;

FIG. 4 illustrates an example of a system;

FIG. 5 illustrates an example of a series of logs;

FIG. 6 illustrates an example of a series of logs;

FIG. 7 illustrates an example of a workflow;

FIG. 8 illustrates an example of a graphical user interface (GUI) that includes an example of a series of logs;

FIG. 9 shows an example of a graphical user interface (GUI) that includes examples of types of logs assessed by a model;

FIG. 10 illustrates an example of a framework;

FIG. 11 illustrates an example of a method;

FIG. 12 illustrates an example of a method and an example of a system; and

FIG. 13 illustrates examples of computer and network equipment.

### DETAILED DESCRIPTION

This description is not to be taken in a limiting sense, but rather is made merely for the purpose of describing the general principles of the implementations. The scope of the described implementations should be ascertained with reference to the issued claims.

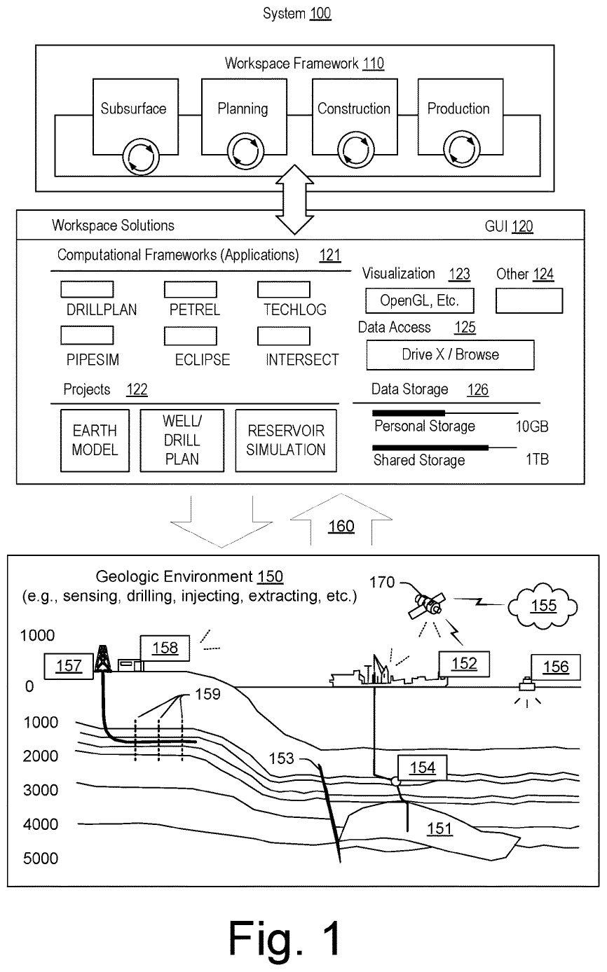

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. A geologic environment 150 may be outfitted with a variety of sensors, detectors, actuators, etc. In such an environment, various types of equipment such as, for example, equipment 152 may include communication circuitry to receive and to transmit information, optionally with respect to one or more networks 155. Such information may include information associated with downhole equipment 154, which may be equipment to acquire information, to assist with resource recovery, etc. Other equipment 156 may be located remote from a wellsite and include sensing, detecting, emitting, or other circuitry. Such equipment may include storage and communication circuitry to store and to communicate data, instructions, etc. One or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc., may exist where an assessment of such variations may assist with planning, operations, etc., to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). Such an environment can provide for operations that involve one or more frameworks. The DELFI environment may be referred to as the DELFI framework, which may be a framework of frameworks. The DELFI environment can include various other frameworks, which may operate using one or more types of models (e.g., simulation models, etc.).

The TECHLOG framework can handle and process field and laboratory data for a variety of geologic environments (e.g., deepwater exploration, shale, etc.). The TECHLOG framework can structure wellbore data for analyses, planning, etc.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). The PIPESIM simulator may be an optimizer that can optimize one or more operational scenarios at least in part via simulation of physical phenomena.

The ECLIPSE framework provides a reservoir simulator with numerical solvers for prediction of dynamic behavior for various types of reservoirs and development schemes.

The INTERSECT framework provides a high-resolution reservoir simulator for simulation of geological features and quantification of uncertainties, for example, by creating production scenarios and, with the integration of precise models of the surface facilities and field operations, the INTERSECT framework can produce results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150, and feedback 160 can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

Visualization features may provide for visualization of various earth models, properties, etc., in one or more dimensions. As an example, visualization features may include one or more control features for control of equipment, which can include, for example, field equipment that can perform one or more field operations. A workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.). Field acquisition equipment may be utilized to acquire seismic data, which may be in the form of traces where a trace can include values organized with respect to time and/or depth (e.g., consider 1D, 2D, 3D or 4D seismic data).

A model may be a simulated version of a geologic environment where a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. While several simulators are illustrated in the example of FIG. 1, one or more other simulators may be utilized, additionally or alternatively.

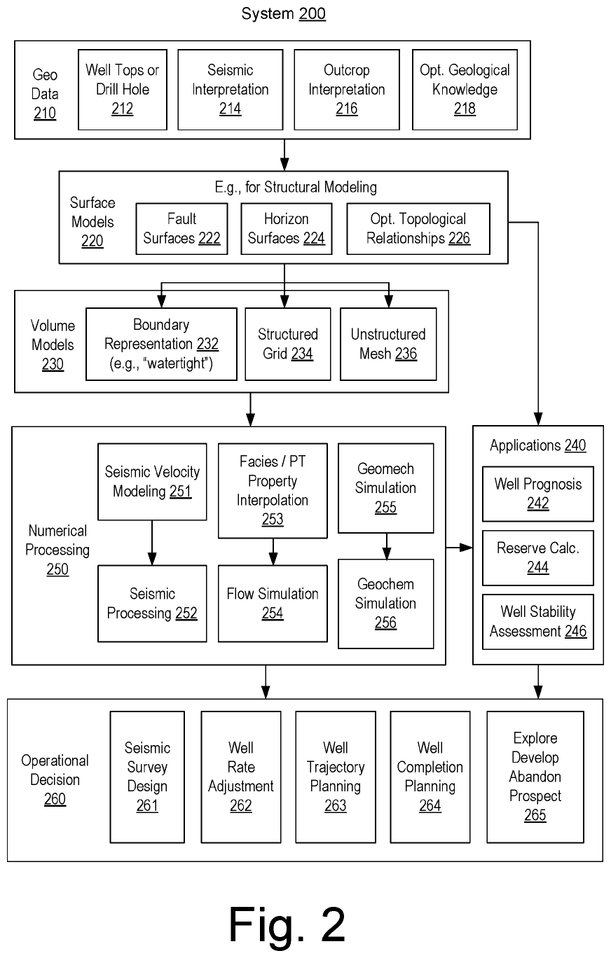

FIG. 2 shows an example of a system 200 that can be operatively coupled to one or more databases, data streams, etc. For example, one or more pieces of field equipment, laboratory equipment, computing equipment (e.g., local and/or remote), etc., can provide and/or generate data that may be utilized in the system 200.

As shown, the system 200 can include a geological/geophysical data block 210, a surface models block 220 (e.g., for one or more structural models), a volume modules block 230, an applications block 240, a numerical processing block 250 and an operational decision block 260. As shown in the example of FIG. 2, the geological/geophysical data block 210 can include data from well tops or drill holes 212, data from seismic interpretation 214, data from outcrop interpretation and optionally data from geological knowledge. As an example, the geological/geophysical data block 210 can include data from digital images, which can include digital images of cores, cuttings, cavings, outcrops, etc. As to the surface models block 220, it may provide for creation, editing, etc. of one or more surface models based on, for example, one or more of fault surfaces 222, horizon surfaces 224 and optionally topological relationships 226. As to the volume models block 230, it may provide for creation, editing, etc. of one or more volume models based on, for example, one or more of boundary representations 232 (e.g., to form a watertight model), structured grids 234 and unstructured meshes 236.

As shown in the example of FIG. 2, the system 200 may allow for implementing one or more workflows, for example, where data of the data block 210 are used to create, edit, etc. one or more surface models of the surface models block 220, which may be used to create, edit, etc. one or more volume models of the volume models block 230. As indicated in the example of FIG. 2, the surface models block 220 may provide one or more structural models, which may be input to the applications block 240. For example, such a structural model may be provided to one or more applications, optionally without performing one or more processes of the volume models block 230 (e.g., for purposes of numerical processing by the numerical processing block 250). Accordingly, the system 200 may be suitable for one or more workflows for structural modeling (e.g., optionally without performing numerical processing per the numerical processing block 250).

As to the applications block 240, it may include applications such as a well prognosis application 242, a reserve calculation application 244 and a well stability assessment application 246. As to the numerical processing block 250, it may include a process for seismic velocity modeling 251 followed by seismic processing 252, a process for facies and petrophysical property interpolation 253 followed by flow simulation 254, and a process for geomechanical simulation 255 followed by geochemical simulation 256. As indicated, as an example, a workflow may proceed from the volume models block 230 to the numerical processing block 250 and then to the applications block 240 and/or to the operational decision block 260. As another example, a workflow may proceed from the surface models block 220 to the applications block 240 and then to the operational decisions block 260 (e.g., consider an application that operates using a structural model).

In the example of FIG. 2, the operational decisions block 260 may include a seismic survey design process 261, a well rate adjustment process 252, a well trajectory planning process 263, a well completion planning process 264 and a process for one or more prospects, for example, to decide whether to explore, develop, abandon, etc. a prospect.

Referring again to the data block 210, the well tops or drill hole data 212 may include spatial localization, and optionally surface dip, of an interface between two geological formations or of a subsurface discontinuity such as a geological fault; the seismic interpretation data 214 may include a set of points, lines or surface patches interpreted from seismic reflection data, and representing interfaces between media (e.g., geological formations in which seismic wave velocity differs) or subsurface discontinuities; the outcrop interpretation data 216 may include a set of lines or points, optionally associated with measured dip, representing boundaries between geological formations or geological faults, as interpreted on the earth surface; and the geological knowledge data 218 may include, for example knowledge of the paleo-tectonic and sedimentary evolution of a region.

As to a structural model, it may be, for example, a set of gridded or meshed surfaces representing one or more interfaces between geological formations (e.g., horizon surfaces) or mechanical discontinuities (fault surfaces) in the subsurface. As an example, a structural model may include some information about one or more topological relationships between surfaces (e.g., fault A truncates fault B, fault B intersects fault C, etc.).

As to the facies and petrophysical property interpolation 253, it may include an assessment of type of rocks and of their petrophysical properties (e.g., porosity, permeability), for example, optionally in areas not sampled by well logs or coring. As an example, such an interpolation may be constrained by interpretations from log and core data, and by prior geological knowledge.

As to the various applications of the applications block 240, the well prognosis application 242 may include predicting type and characteristics of geological formations that may be encountered by a drill bit, and location where such rocks may be encountered (e.g., before a well is drilled); the reserve calculations application 244 may include assessing total amount of hydrocarbons or ore material present in a subsurface environment (e.g., and estimates of which proportion can be recovered, given a set of economic and technical constraints); and the well stability assessment application 246 may include estimating risk that a well, already drilled or to-be-drilled, will collapse or be damaged due underground stress.

As to the operational decision block 260, the seismic survey design process 261 may include deciding where to place seismic sources and receivers to optimize the coverage and quality of the collected seismic information while minimizing cost of acquisition; the well rate adjustment process 262 may include controlling injection and production well schedules and rates (e.g., to maximize recovery and production); the well trajectory planning process 263 may include designing a well trajectory to maximize potential recovery and production while minimizing drilling risks and costs; the well trajectory planning process 264 may include selecting proper well tubing, casing and completion (e.g., to meet expected production or injection targets in specified reservoir formations); and the prospect process 265 may include decision making, in an exploration context, to continue exploring, start producing or abandon prospects (e.g., based on an integrated assessment of technical and financial risks against expected benefits).

The system 200 can include and/or can be operatively coupled to a system such as the system 100 of FIG. 1. For example, the workspace framework 110 may provide for instantiation of, rendering of, interactions with, etc., the graphical user interface (GUI) 120 to perform one or more actions as to the system 200. In such an example, access may be provided to one or more frameworks (e.g., DRILLPLAN, PETREL, TECHLOG, PIPESIM, ECLIPSE, INTERSECT, etc.). One or more frameworks may provide for geo data acquisition as in block 210, for structural modeling as in block 220, for volume modeling as in block 230, for running an application as in block 240, for numerical processing as in block 250, for operational decision making as in block 260, etc.

As an example, the system 200 may provide for monitoring data, which can include geo data per the geo data block 210. In various examples, geo data may be acquired during one or more operations. For example, consider acquiring geo data during drilling operations via downhole equipment and/or surface equipment. As an example, the operational decision block 260 can include capabilities for monitoring, analyzing, etc., such data for purposes of making one or more operational decisions, which may include controlling equipment, revising operations, revising a plan, etc. In such an example, data may be fed into the system 200 at one or more points where the quality of the data may be of particular interest. For example, data quality may be characterized by one or more metrics where data quality may provide indications as to trust, probabilities, etc., which may be germane to operational decision making and/or other decision making.

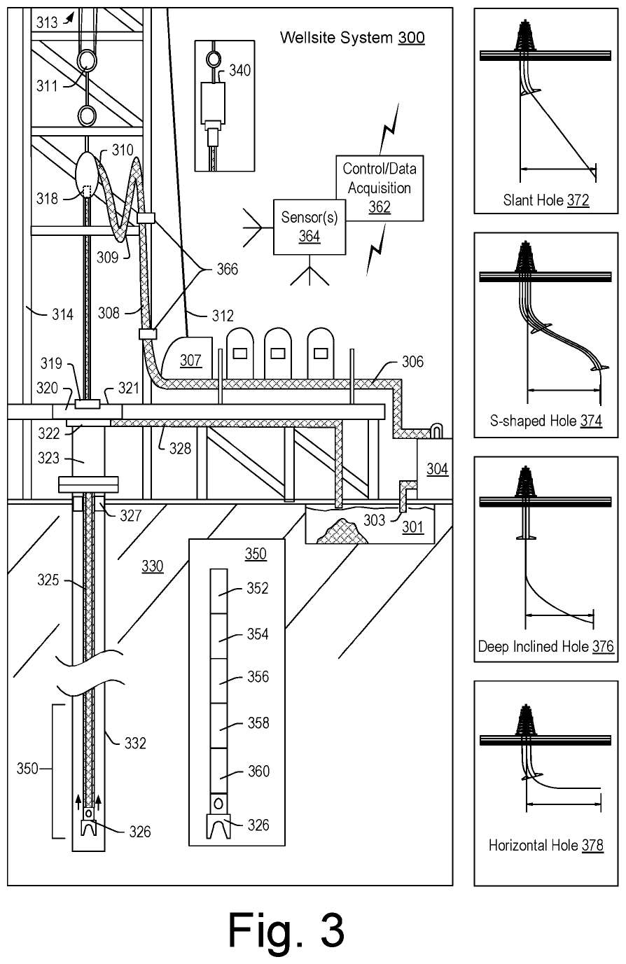

FIG. 3 shows an example of a wellsite system 300 (e.g., at a wellsite that may be onshore or offshore). As shown, the wellsite system 300 can include a mud tank 301 for holding mud and other material (e.g., where mud can be a drilling fluid), a suction line 303 that serves as an inlet to a mud pump 304 for pumping mud from the mud tank 301 such that mud flows to a vibrating hose 306, a drawworks 307 for winching drill line or drill lines 312, a standpipe 308 that receives mud from the vibrating hose 306, a kelly hose 309 that receives mud from the standpipe 308, a gooseneck or goosenecks 310, a traveling block 311, a crown block 313 for carrying the traveling block 311 via the drill line or drill lines 312, a derrick 314, a kelly 318 or a top drive 340, a kelly drive bushing 319, a rotary table 320, a drill floor 321, a bell nipple 322, one or more blowout preventors (BOPs) 323, a drillstring 325, a drill bit 326, a casing head 327 and a flow pipe 328 that carries mud and other material to, for example, the mud tank 301.

In the example system of FIG. 3, a borehole 332 is formed in subsurface formations 330 by rotary drilling; noting that various example embodiments may also use one or more directional drilling techniques, equipment, etc.

As shown in the example of FIG. 3, the drillstring 325 is suspended within the borehole 332 and has a drillstring assembly 350 that includes the drill bit 326 at its lower end. As an example, the drillstring assembly 350 may be a bottom hole assembly (BHA).

The wellsite system 300 can provide for operation of the drillstring 325 and other operations. As shown, the wellsite system 300 includes the traveling block 311 and the derrick 314 positioned over the borehole 332. As mentioned, the wellsite system 300 can include the rotary table 320 where the drillstring 325 pass through an opening in the rotary table 320.

As shown in the example of FIG. 3, the wellsite system 300 can include the kelly 318 and associated components, etc., or the top drive 340 and associated components. As to a kelly example, the kelly 318 may be a square or hexagonal metal/alloy bar with a hole drilled therein that serves as a mud flow path. The kelly 318 can be used to transmit rotary motion from the rotary table 320 via the kelly drive bushing 319 to the drillstring 325, while allowing the drillstring 325 to be lowered or raised during rotation. The kelly 318 can pass through the kelly drive bushing 319, which can be driven by the rotary table 320. As an example, the rotary table 320 can include a master bushing that operatively couples to the kelly drive bushing 319 such that rotation of the rotary table 320 can turn the kelly drive bushing 319 and hence the kelly 318. The kelly drive bushing 319 can include an inside profile matching an outside profile (e.g., square, hexagonal, etc.) of the kelly 318; however, with slightly larger dimensions so that the kelly 318 can freely move up and down inside the kelly drive bushing 319.

As to a top drive example, the top drive 340 can provide functions performed by a kelly and a rotary table. The top drive 340 can turn the drillstring 325. As an example, the top drive 340 can include one or more motors (e.g., electric and/or hydraulic) connected with appropriate gearing to a short section of pipe called a quill, that in turn may be screwed into a saver sub or the drillstring 325 itself. The top drive 340 can be suspended from the traveling block 311, so the rotary mechanism is free to travel up and down the derrick 314. As an example, a top drive 340 may allow for drilling to be performed with more joint stands than a kelly/rotary table approach.

In the example of FIG. 3, the mud tank 301 can hold mud, which can be one or more types of drilling fluids. As an example, a wellbore may be drilled to produce fluid, inject fluid or both (e.g., hydrocarbons, minerals, water, etc.).

In the example of FIG. 3, the drillstring 325 (e.g., including one or more downhole tools) may be composed of a series of pipes threadably connected together to form a long tube with the drill bit 326 at the lower end thereof. As the drillstring 325 is advanced into a wellbore for drilling, at some point in time prior to or coincident with drilling, the mud may be pumped by the pump 304 from the mud tank 301 (e.g., or other source) via the lines 306, 308 and 309 to a port of the kelly 318 or, for example, to a port of the top drive 340. The mud can then flow via a passage (e.g., or passages) in the drillstring 325 and out of ports located on the drill bit 326 (see, e.g., a directional arrow). As the mud exits the drillstring 325 via ports in the drill bit 326, it can then circulate upwardly through an annular region between an outer surface(s) of the drillstring 325 and surrounding wall(s) (e.g., open borehole, casing, etc.), as indicated by directional arrows. In such a manner, the mud lubricates the drill bit 326 and carries heat energy (e.g., frictional or other energy) and formation cuttings to the surface where the mud may be returned to the mud tank 301, for example, for recirculation with processing to remove cuttings and other material.

In the example of FIG. 3, processed mud pumped by the pump 304 into the drillstring 325 may, after exiting the drillstring 325, form a mudcake that lines the wellbore which, among other functions, may reduce friction between the drillstring 325 and surrounding wall(s) (e.g., borehole, casing, etc.). A reduction in friction may facilitate advancing or retracting the drillstring 325. During a drilling operation, the entire drillstring 325 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 326 of the drillstring 325 at a bottom of a wellbore, pumping of the mud commences to lubricate the drill bit 326 for purposes of drilling to enlarge the wellbore. As mentioned, the mud can be pumped by the pump 304 into a passage of the drillstring 325 and, upon filling of the passage, the mud may be used as a transmission medium to transmit energy, for example, energy that may encode information as in mud-pulse telemetry. Characteristics of the mud can be utilized to determine how pulses are transmitted (e.g., pulse shape, energy loss, transmission time, etc.).

As an example, mud-pulse telemetry equipment may include a downhole device configured to effect changes in pressure in the mud to create an acoustic wave or waves upon which information may modulated. In such an example, information from downhole equipment (e.g., one or more modules of the drillstring 325) may be transmitted uphole to an uphole device, which may relay such information to other equipment for processing, control, etc.

As an example, telemetry equipment may operate via transmission of energy via the drillstring 325 itself. For example, consider a signal generator that imparts coded energy signals to the drillstring 325 and repeaters that may receive such energy and repeat it to further transmit the coded energy signals (e.g., information, etc.).

As an example, the drillstring 325 may be fitted with telemetry equipment 352 that includes a rotatable drive shaft, a turbine impeller mechanically coupled to the drive shaft such that the mud can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 3, an uphole control and/or data acquisition system 362 may include circuitry to sense pressure pulses generated by telemetry equipment 352 and, for example, communicate sensed pressure pulses or information derived therefrom for process, control, etc.

The assembly 350 of the illustrated example includes a logging-while-drilling (LWD) module 354, a measurement-while-drilling (MWD) module 356, an optional module 358, a rotary-steerable system (RSS) and/or motor 360, and the drill bit 326. Such components or modules may be referred to as tools where a drillstring can include a plurality of tools. Such components or modules may provide for generation of logs, which may include, for example, one or more types of logs.

As to an RSS, it involves technology utilized for directional drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling can commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

One approach to directional drilling involves a mud motor; however, a mud motor can present some challenges depending on factors such as rate of penetration (ROP), transferring weight to a bit (e.g., weight on bit, WOB) due to friction, etc. A mud motor can be a positive displacement motor (PDM) that operates to drive a bit (e.g., during directional drilling, etc.). A PDM operates as drilling fluid is pumped through it where the PDM converts hydraulic power of the drilling fluid into mechanical power to cause the bit to rotate.

As an example, a PDM may operate in a combined rotating mode where surface equipment is utilized to rotate a bit of a drillstring (e.g., a rotary table, a top drive, etc.) by rotating the entire drillstring and where drilling fluid is utilized to rotate the bit of the drillstring. In such an example, a surface RPM (SRPM) may be determined by use of the surface equipment and a downhole RPM of the mud motor may be determined using various factors related to flow of drilling fluid, mud motor type, etc. As an example, in the combined rotating mode, bit RPM can be determined or estimated as a sum of the SRPM and the mud motor RPM, assuming the SRPM and the mud motor RPM are in the same direction.

The LWD module 354 may be housed in a suitable type of drill collar and can contain one or a plurality of selected types of logging tools. It will also be understood that more than one LWD and/or MWD module can be employed. An LWD module can include capabilities for measuring, processing, and storing information, as well as for communicating with the surface equipment. In the illustrated example, the LWD module 354 may include a seismic measuring device.

The MWD module 356 may be housed in a suitable type of drill collar and can contain one or more devices for measuring characteristics of the drillstring 325 and the drill bit 326. As an example, the MWD module 356 may include equipment for generating electrical power, for example, to power various components of the drillstring 325. As an example, the MWD module 356 may include the telemetry equipment 352, for example, where the turbine impeller can generate power by flow of the mud; it being understood that other power and/or battery systems may be employed for purposes of powering various components. As an example, the MWD module 356 may include one or more of the following types of measuring devices: a weight-on-bit measuring device, a torque measuring device, a vibration measuring device, a shock measuring device, a stick slip measuring device, a direction measuring device, and an inclination measuring device.

FIG. 3 also shows some examples of types of holes that may be drilled. For example, consider a slant hole 372, an S-shaped hole 374, a deep inclined hole 376 and a horizontal hole 378.

A drilling operation can include directional drilling where, for example, at least a portion of a well includes a curved axis. For example, consider a radius that defines curvature where an inclination with regard to the vertical may vary until reaching an angle between approximately 30 degrees and approximately 60 degrees or, for example, an angle to approximately 90 degrees or possibly greater than approximately 90 degrees.

A directional well can include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As explained, a system may be a steerable system and may include equipment to perform a method such as geosteering. A steerable system can include equipment on a lower part of a drillstring which, just above a drill bit, a bent sub may be mounted. Above directional drilling equipment, a drillstring can include MWD equipment that provides real time or near real time data of interest (e.g., inclination, direction, pressure, temperature, real weight on the drill bit, torque stress, etc.) and/or LWD equipment. As to the latter, LWD equipment can make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, can allow for implementing a geosteering method. Such a method can include navigating a subsurface environment to follow a desired route to reach a desired target or targets.

A drillstring may include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

Geosteering can include intentional directional control of a wellbore based on results of downhole geological logging measurements in a manner that aims to keep a directional wellbore within a desired region, zone (e.g., a pay zone), etc. Geosteering may include directing a wellbore to keep the wellbore in a particular section of a reservoir, for example, to minimize gas and/or water breakthrough and, for example, to maximize economic production from a well that includes the wellbore.

Referring again to FIG. 3, the wellsite system 300 can include one or more sensors 364 that are operatively coupled to the control and/or data acquisition system 362. As an example, a sensor or sensors may be at surface locations. As an example, a sensor or sensors may be at downhole locations. As an example, a sensor or sensors may be at one or more remote locations that are not within a distance of the order of approximately one hundred meters from the wellsite system 300.

The system 300 can include one or more sensors 366 that can sense and/or transmit signals to a fluid conduit such as a drilling fluid conduit (e.g., a drilling mud conduit). For example, in the system 300, the one or more sensors 366 can be operatively coupled to portions of the standpipe 308 through which mud flows. As an example, a downhole tool can generate pulses that can travel through the mud and be sensed by one or more of the one or more sensors 366. In such an example, the downhole tool can include associated circuitry such as, for example, encoding circuitry that can encode signals, for example, to reduce demands as to transmission. Circuitry at the surface may include decoding circuitry to decode encoded information transmitted at least in part via mud-pulse telemetry. Circuitry at the surface may include encoder circuitry and/or decoder circuitry and circuitry downhole may include encoder circuitry and/or decoder circuitry. As an example, the system 300 can include a transmitter that can generate signals that can be transmitted downhole via mud (e.g., drilling fluid) as a transmission medium.

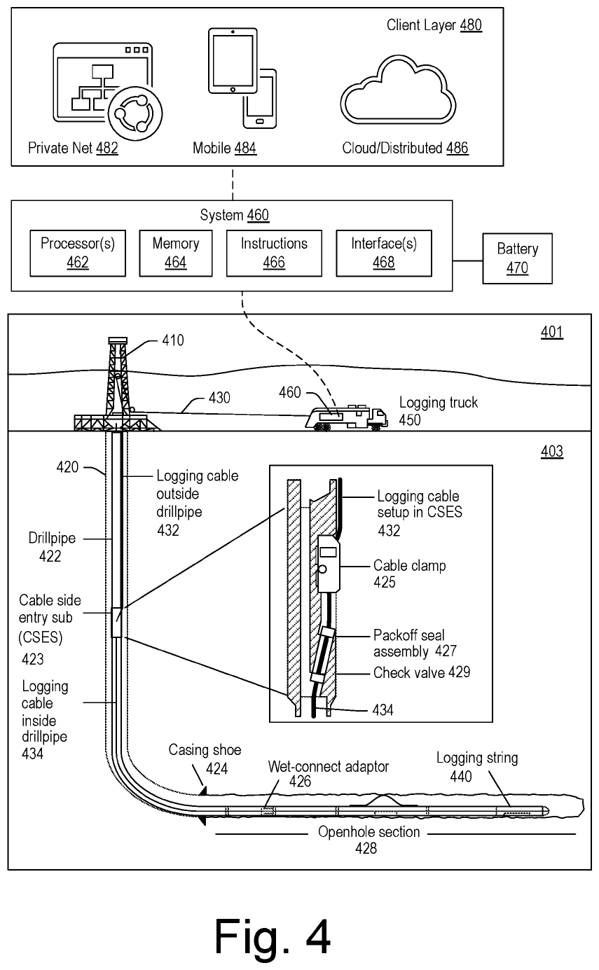

FIG. 4 shows an example of an environment 401 that includes a subterranean portion 403 where a rig 410 is positioned at a surface location above a bore 420. In the example of FIG. 4, various wirelines services equipment can be operated to perform one or more wirelines services including, for example, acquisition of data from one or more positions within the bore 420.

As an example, a wireline tool and/or a wireline service may provide for acquisition of data, analysis of data, data-based determinations, data-based decision making, etc. Some examples of wireline data can include gamma ray (GR), spontaneous potential (SP), caliper (CALI), shallow resistivity (LLS and ILD), deep resistivity (LLD and ILD), density (RHOB), neutron porosity (BPHI or TNPH or NPHI), sonic (DT), photoelectric (PEF), permittivity and conductivity.

In the example of FIG. 4, the bore 420 includes drillpipe 422, a casing shoe 424, a cable side entry sub (CSES) 423, a wet-connector adaptor 426 and an openhole section 428. As an example, the bore 420 can be a vertical bore or a deviated bore where one or more portions of the bore may be vertical and one or more portions of the bore may be deviated, including substantially horizontal.

In the example of FIG. 4, the CSES 423 includes a cable clamp 425, a packoff seal assembly 427 and a check valve 429. These components can provide for insertion of a logging cable 430 that includes a portion 432 that runs outside the drillpipe 422 to be inserted into the drillpipe 422 such that at least a portion 434 of the logging cable runs inside the drillpipe 422. In the example of FIG. 4, the logging cable 430 runs past the casing shoe 424 and the wet-connect adaptor 426 and into the openhole section 428 to a logging string 440.

As shown in the example of FIG. 4, a logging truck 450 (e.g., a wirelines services vehicle) can deploy the wireline 430 under control of a system 460. As shown in the example of FIG. 4, the system 460 can include one or more processors 462, memory 464 operatively coupled to at least one of the one or more processors 462, instructions 466 that can be, for example, stored in the memory 464, and one or more interfaces 468. As an example, the system 460 can include one or more processor-readable media that include processor-executable instructions executable by at least one of the one or more processors 462 to cause the system 460 to control one or more aspects of equipment of the logging string 440 and/or the logging truck 450. In such an example, the memory 464 can be or include the one or more processor-readable media where the processor-executable instructions can be or include instructions. As an example, a processor-readable medium can be a computer-readable storage medium that is not a signal and that is not a carrier wave.

FIG. 4 also shows a battery 470 that may be operatively coupled to the system 460, for example, to power the system 460. As an example, the battery 470 may be a back-up battery that operates when another power supply is unavailable for powering the system 460 (e.g., via a generator of the wirelines truck 450, a separate generator, a power line, etc.). As an example, the battery 470 may be operatively coupled to a network, which may be a cloud network. As an example, the battery 470 can include smart battery circuitry and may be operatively coupled to one or more pieces of equipment via a SMBus or other type of bus.

As an example, the system 460 can be operatively coupled to a client layer 480. In the example of FIG. 4, the client layer 480 can include features that allow for access and interactions via one or more private networks 482, one or more mobile platforms and/or mobile networks 484 and via the “cloud” 486, which may be considered to include distributed equipment that forms a network such as a network of networks. As an example, the system 460 can include circuitry to establish a plurality of connections (e.g., sessions). As an example, connections may be via one or more types of networks. As an example, connections may be client-server types of connections where the system 460 operates as a server in a client-server architecture. For example, clients may log-in to the system 460 where multiple clients may be handled, optionally simultaneously.

While the example of FIG. 4 shows the system 460 as being associated with the logging truck 450, one or more features of the system 460 may be included in a downhole assembly, which may be a wireline assembly and/or a LWD assembly. In such an approach, various computations may be performed downhole where results thereof may be optionally transmitted to surface (e.g., to the logging truck 450, etc.) using one or more telemetric technologies and/or techniques (e.g., mud-pulse telemetry, wireline, etc.).

As an example, a tool can include one or more features of the ORA platform (SLB, Houston, Texas). The ORA platform includes various tool options, which include metrology options (e.g., various types of sensors that may be disposed in a sensor array, etc.). For example, consider a tool that includes a fluid in situ scanner that can measure one or more of density and viscosity, resistivity, and full-spectrum viscosity. As an example, a tool can include one or more pressure sensors (e.g., quartz, etc.) and/or one or more temperature sensors. As an example, a tool can include one or more sensors for measurement of oil, water and gas volume fraction, composition, color, etc. As to composition sensing, consider sensing of C₁ to C₆ or C₆₊ (e.g., with uncertainty less than approximately 6 weight percent) and, for example, sensing of CO₂. As to fluid density, consider a range from approximately 0.01 to 2.0 g/cm³. As to fluid viscosity, consider a range from 0.1 to 300 cP. As to color, consider optical density as a measurement. As to optical measurements, for example, a tool can include a spectrophotometer, a fluorescence meter, etc.

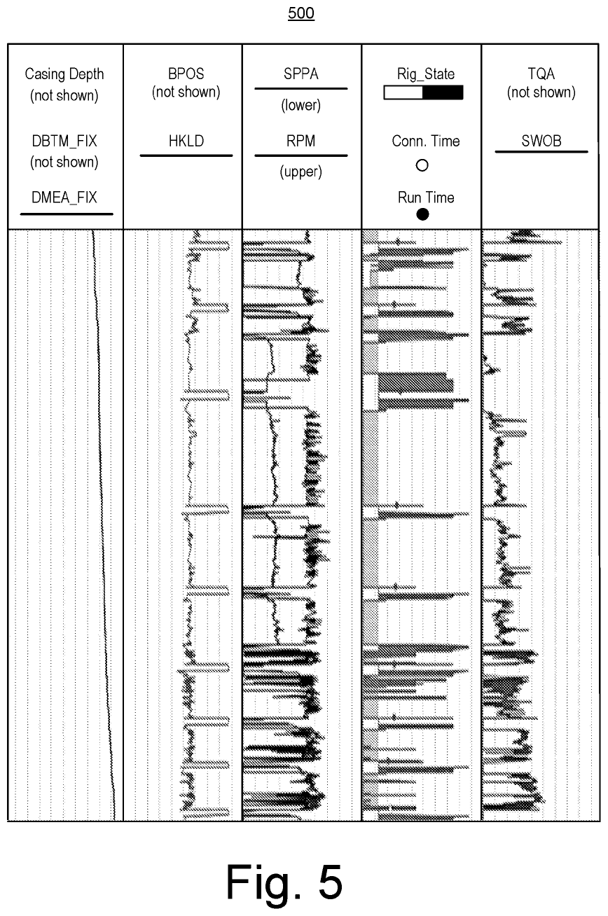

FIG. 5 shows an example of a series of logs 500 as acquired during drilling operations. In the example of FIG. 5, the logs 500 include a depth log (e.g., measured depth) that may have a span of 0 ft to 4,500 ft, a block position (BPOS) log that may have a span of 110 ft to 0 ft, a hook load (HKLD) log that may have a span from 250 klbf to 0 klbf, a standpipe pressure (SPPA) log that may have a span from 0 psi to 4,000 psi, an RPM log that may have a span from 0 c/min to 90 c/min, a rig state log with connection and run times that may have spans from 0 min to 16 min, a surface torque (TQA) log that may have a span from 0 kft.lbf to 21,821.02 kft.lbf, and a surface weight on bit (SWOB) log that may have a span from 0 klbf to 50 klbf. Such logs can be acquired for various sections of a well, which can intersect and/or be disposed within one or more formation types. As to some examples of logs associated with drilling, consider one or more of bit depth (DBTM), WOB, measured depth (MD or DMEA), mud flow rate in (FLWI), RPM, surface torque (STOR), standpipe pressure (SPPA), hook load (HKLD), block position (BPOS), bit size (BS), caliper, etc. As an example, depth may be provided in one or more manners, for example, with respect to casing, open hole, measured depth (MD), true vertical depth, bit true measured depth (DBTM), hole true measured depth (DMEA), etc.

As an example, a formation type may be characterized by petrophysical properties. As an example, the logs 500 can be related to drill bit to formation interaction and, for example, drillstring to formation interaction (e.g., consider friction between a drillstring and a borewall). During drilling, a drill bit can break rock of a formation where the interaction between the drill bit and the rock can be characterized by physical parameters such as, for example, torque, which may be measured at surface (e.g., at a rig) and/or measured downhole (e.g., by one or more downhole sensors).

As an example, a metric known as mechanical specific energy (MSE) can be determined, which is the energy required to remove a unit volume of rock. For optimal drilling efficiency, an objective can be to minimize MSE and to maximize the rate of penetration (ROP). To control MSE, drillers can control weight on bit (WOB), torque (TQA), ROP, and drill bit revolutions per minute (RPM).

As an example, a drilling operation may be performed at least in part using a controller, which may be automated, semi-automated, etc. As an example, automation may be available at one or more levels where a human may be in the loop (HITL) to a greater or lesser extent depending on level. As an example, a controller may switch a level from one level to another level depending on feedback, performance, etc.

As an example, a self-adapting drilling system may enable a driller to enter a relatively high ROP set point where the system performs actions for self-adaptation, which can reduce time and effort spent on tuning, etc. As an example, a system may provide an ROP-average feature that can assist in dynamically adjusting the ROP set point and limit(s) based on one or more factors, which can include, for example, current well profile, including one or more of weight on bit, top drive torque (e.g., surface torque), and differential pressure.

During drilling operations, torque and drag (T&D) can refer to effects as to geometry and other aspects that a borehole may have on turning and pulling of a drillstring. T&D can differ depending on drilling mode. For example, consider a sliding mode and a rotating mode. In the sliding mode, the drillstring may be oscillated or not and torque may be low, however axial drag can be high and lock-up possible. Lock-up is the buckling of a section of the drillstring within a borehole and can prohibit transmission of force to a drill bit or BHA. In the rotational mode, the drillstring is rotated (e.g., in a single rotational direction) at a rate which tends to reduce drag to a relatively very low level of force. In the rotational mode, lock-up may be quite improbable, however, torque can be relatively high.

Other aspects of T&D can include maximum drillstring weight available for a drill bit, drillstring buckling (lock-up), friction factors, and maximum available torque for a drill bit.

As explained, torque can be a useful measure during drilling operations. As shown in the example logs 500 of FIG. 5, a log can be a torque log, which can be a surface torque log as related to one or more mechanisms (e.g., top drive, rotary table, etc.). As an example, a torque log can include data that can be correlated to data in one or more other logs. As such, a torque log can be utilized to estimate or predict data, behavior, etc., in one or more other parameters.

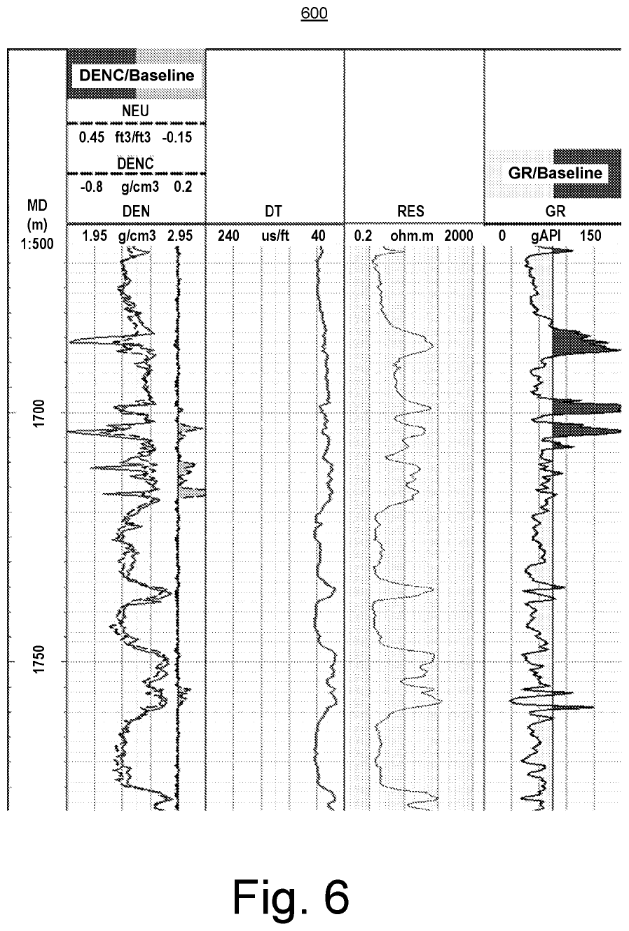

FIG. 6 shows an example of a series of logs 600 as acquired during logging and/or drilling operations (e.g., consider LWD, etc.). In FIG. 6, the logs 600 are shown with respect to measured depth (MD) in meters over a MD range of approximately 100 m and include a neutron (NEU) log with a span of 0.45 cubic feet to −0.15 cubic feet, a density correction (DENC) log with a span of −0.8 g/cm³ to 0.2 g/cm³, a density (DEN) log with a span of 1.95 g/cm³ to 2.95 g/cm³, a slowness (DT) log with a span of 240 μs/ft to 40 μs/ft (e.g., a sonic log), a resistivity (RES) log with a span from 0.2 ohm·m to 2000 ohm·m, and a gamma ray (GR) law with a span from 0 gAPI to 150 gAPI.

In the example of FIG. 6, the logs 600 can be acquired using one or more techniques that can include one or more techniques that involve emitting energy and receiving energy where received energy depends on properties of a formation and/or a borehole wall. In various instances, mud (e.g., drilling fluid) may line a borehole such that energy interacts with the mud where such energy may also interact with the formation behind the mud. As the properties of mud can depend on drilling techniques implemented, mud properties may vary. For example, consider oil-based mud, water-based mud, synthetic mud, etc. As an example, salinity of mud may vary where log data can depend on or otherwise be affected by mud salinity. As to mud, mud filtrate can alter measurements. Filtrate is liquid that passes through a filter cake from a slurry held against the filter medium, driven by differential pressure, noting that dynamic or static filtration can produce a filtrate. Mud filtrate can penetrate a formation and may drive formation fluid to move, which may alter one or more physical properties of the formation (e.g., formation and formation fluid).

As an example, a framework such as, for example, the TECHLOG framework (SLB, Houston, Texas) may be utilized to acquire, assess, alter, etc., one or more logs, which can include drilling logs as in FIG. 5 and petrophysical logs as in FIG. 6. As an example, the TECHLOG framework may provide for handling of logs such as bit size (BS), caliper (CALI), gamma ray (GR), shallow resistivity (RES_SLW), medium resistivity (RES_MED), deep resistivity (RES_DEP), density (DEN), density correction (DENC), neutron porosity (NEU), sonic (DT), photo electric log (PEF) and lithology (LITH-Petrel), etc. Such logs may be used to calculate volume of rock (e.g., shale, etc.), porosity, water saturation, and permeability of one or more types of formations.

While various logs are described with respect to depth such as, for example, measured depth, one or more logs may be described with respect to time. In either instance, log data can be series data such as depth series data and/or time series data.

As an example, a framework can be a computational framework suited for performing one or more workflows. For example, consider a framework for best log selection for petrophysical interpretation and/or drilling interpretation using a combined permutation and machine learning (ML) approach. As an example, such a framework can provide a data preparation automation process for selection of the best candidate logs for a set of measurement types.

As explained, log data (e.g., log measurements) can describe a physics system that involves interactions with one or more types of formations. As an example, a framework can implement a selection method, where logs are grouped by their measurement type and based on a permutation matrix of available log candidates matching a measurement type in a well. Such a matrix can be built in such a way that allows for a unique occurrence for each log measurement type per scenario. As an example, an ML model-based prediction of a target log can score each log combination from the matrix and push forward the logs with the highest positive scores. As an example, an ML model-based approach may utilize one or more target logs as may be selected from different types of logs. As an example, a target log for logs of drilling operations may be a ROP log. As an example, a target log for logs of petrophysical measurements may be a density log. As an example, in a permutation matrix, a target log may be structured as a last type of log (e.g., in an end column, etc.).

TABLE 1
Example Permutation Matrix

| | Type 1 | Type 2 | Type 3 | Type . . . | Type N |
|---|---|---|---|---|---|
| Scenario 1 | GR 1 | NEU 2 | Sonic 7 | . . . | DEN 2 |
| Scenario 2 | GR 2 | NEU 5 | Sonic 1 | . . . | DEN 3 |
| Scenario 3 | GR 1 | NEU 3 | Sonic 3 | . . . | DEN 5 |
| Scenario M | GR X | NEU Y | Sonic Z | . . . | DEN XY |

Above, the example permutation matrix considers various scenarios, which may be for a particular type of formation, etc. The type of formation may be selected as a base to tie the log data to a physical reality. In such an approach, comparisons (e.g., correlations) can be performed to determine whether one or more logs can predict one or more other logs.

As an example, a framework may implement one or more techniques. As explained, a framework can implement a permutation and ML approach, which may be accompanied by one or more other approaches, which can include one or more existing approaches that are physics-based, where each individual measurement's quality is assessed per a set of user defined rules, or physics-based criteria.

Various issues can exist with log data. For example, historical log data may be altered by one or more workflows where one or more altered versions of the log data are stored to a data store. In such an example, an original version may be unavailable such that available versions are “children” derived from the original version, which may be directly or indirectly via one or more intermediate versions. As an example, a framework can provide for accessing logs from one or more data stores where the framework can process the logs to generate output logs that are suitably acceptable for one or more workflows, which can include, for example, one or more workflows involving machine learning where the output logs can be utilized for one or more of training a machine learning model (ML model) and/or testing an ML model.

As an example, a physical system can refer to a geological formation and/or to a drilling system where the physical system can be characterized by measurements (e.g., log data). As an example, a measurement can be a sensor reading. As mentioned, measurements may be acquired during logging and/or during drilling where logging measurements can include wireline logging measurements, coiled tubing logging measurements, etc., and where drilling measurements may be acquired using a rig control system. In various instances, a combination of measurement types may help to characterize a physical system.

As to a candidate for a measurement type, there may be multiple versions of a measurement where, for example, some may have been altered (e.g., adjusted for time and/or depth shift, environmental effect, mud, etc.) and/or where an adjustment is a result of a human interpretation.

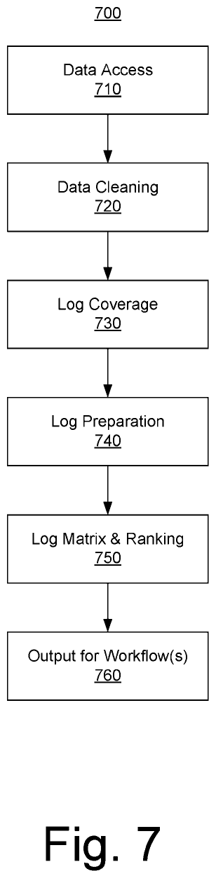

FIG. 7 shows an example of a workflow 700 that can be performed at least in part by a framework. In the example of FIG. 7, the workflow 700 can include an access block 710 for accessing log data, a cleaning block 720 for cleaning accessed log data, a log coverage block 730 for selection of log data that covers a particular formation (e.g., or depth, time, etc.), a log preparation block 740 for preparing log data, a log matrix and ranking block 750 for constructing a permutation matrix and ranking logs with respect to comparisons, and an output block 760 for outputting log data for one or more workflows.

As an example, the workflow 700 can include building a cleaned dataset with proper log measurement type assigned, which may be controlled by a zone of interest (ZOI) selection (e.g., a formation type, etc.); defining a robust control on a selection process of suitable family-driven log selection through logs coverage threshold inside ZOI; defining a permutation matrix that is lists possible combinations of the available logs in a project in a manner that allows for a single occurrence per family per scenario; creating a scenario-based selection process of logs from the available wells and their corresponding datasets inside a project and utilizing a machine learning approach to score how accurately the measurement candidates are able to predict each other (e.g., a process that can assign a score to each permutation realization of the permutation matrix); ranking of resulting realizations of the permutation matrix as to best log combination(s); and persisting a best permutation realization where the process can be repeated for one or more additional ZOIs (e.g., one or more additional geological formations, etc.). Such an approach can be self-cleaning, where logs with problems (e.g., negative values such as “−999” as may be assigned to tag missing data as in the TECHLOG framework) can automatically be excluded from a selection process as such logs are likely to produce relatively low scores and, consequently, have low rankings.

As an example, a framework can process logs to address one or more issues, which can include, for example, depth shifting issues. For example, if some of the measurement type candidates are depth shifted, this can result in poorer cross-correlation estimation (e.g., depth shifted candidates may be lower than the non-depth shifted ones that are appropriately depth matched). As to another example, consider a scenario where an entire set of candidates is depth shifted, which may result in an inability to distinguish scores. As to yet another example, consider bad measurements and/or corrections. In such an example, if some measurement candidates include bad readings (e.g., not physically realistic or otherwise misleading), while other candidates have been corrected, this may impact cross-correlation. As another example, consider inappropriately assigned measurement type. In such an example, if some candidates are inappropriately assigned to a measurement type, the physics system will not be as well described, and these candidates will have a lower cross-correlation score.

As an example, a framework can provide features to perform one or more workflows such as, for example, the workflow 700 of FIG. 7. Such an approach may be applicable where measurement types have some physical cross-correlation that is expected. For example, compression slowness, shear slowness, gamma ray, neutron porosity and bulk density can be expected to have some form of cross-correlation. In contrast, if there is an insufficient physical relationship between measurements, the approach may not be able to select the best candidate(s) for the measurement types.

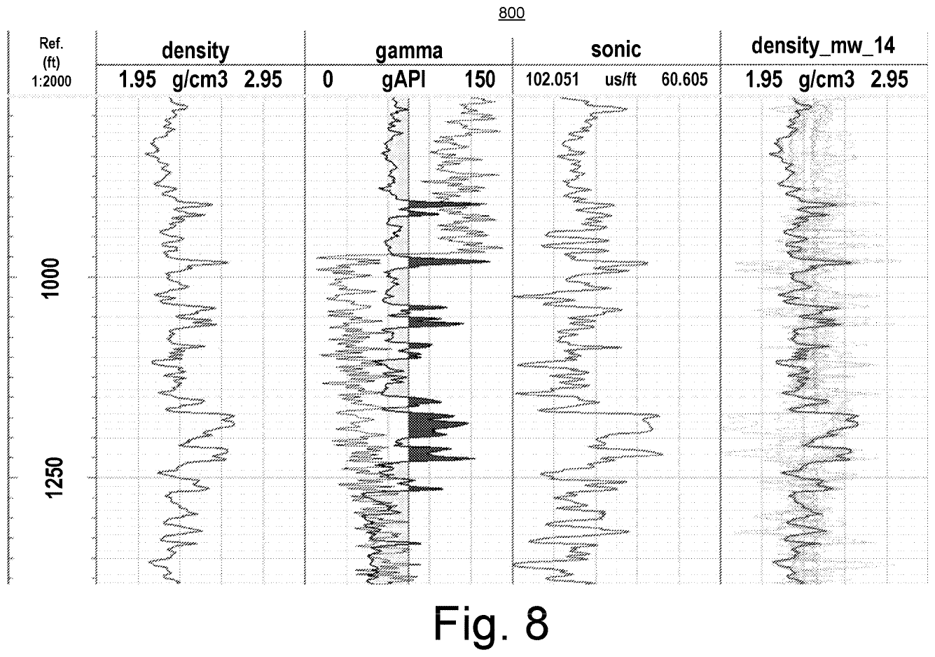

FIG. 8 shows an example of a graphical user interface (GUI) 800 that includes a series of logs that include a depth log in feet, a density log, a gamma ray log, a sonic log and a predicted log (labeled density_mw_14). As to the predicted log, density is highlighted as a predicted log (e.g., a target log) that suitably matches the density log where the underlying other logs are also shown, as may be prepared for purposes of an ML model-based analysis (e.g., using logistic regression, etc.). Hence, for the particular type of formation selected along the depth (see depth log), gamma ray and sonic data can predict density data (e.g., density, gamma ray and sonic data are suitably correlated). As to a score, it may indicate how well the combination of logs (e.g., log data) predicts a target log (e.g., target log data). In the example of FIG. 8, the various versions of each measurement can each yield a different prediction for the true measurement (see, e.g., density in red on the last track). As an example, a framework can be implemented to identify the best version of each measurement (e.g., log data) that will yield the most accurate prediction.

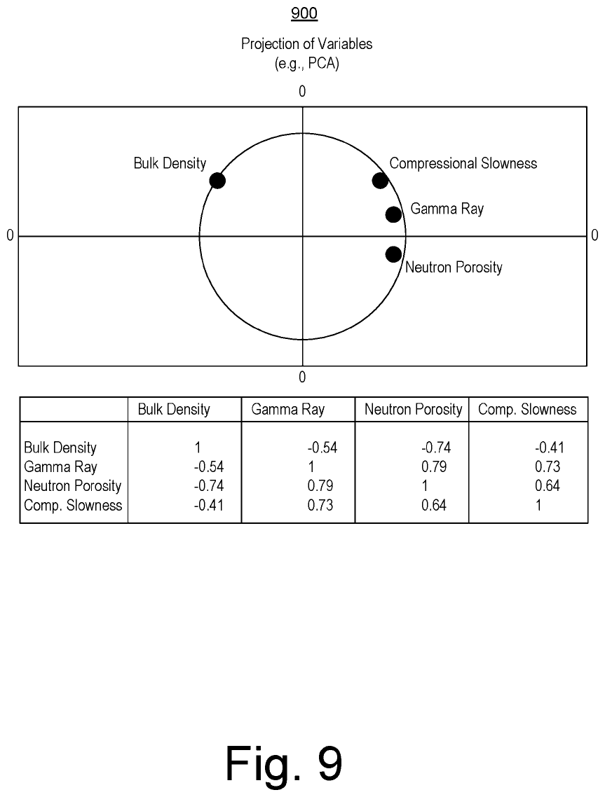

FIG. 9 shows an example of a graphical user interface (GUI) 900 that may be rendered by a framework. In the example of FIG. 9, the GUI 900 includes results from a principal component analysis (PCA). A PCA can be implemented to assess correlations in data through linear transformation into a new coordinate system such that coordinate directions (e.g., principal components) may provide for capturing the largest variation in the data. PCA can be applied as a linear decomposition technique that transforms a set of variables into principal components, as an equivalent set of transformed variables. The principal components are orthogonal (independent of one another) and may be sorted in order of explained variance. A correlation circle may be generated as a visualization that can help to convey how much the original variables are correlated with two of the principal components, which are normally the first two principal components (e.g., PC1 and PC2). In the example of FIG. 9, the projection of variables plot is for the first two principal components where a table includes correlation values where a value of unity (a value of 1) indicates perfect positive correlation, a value of minus 1 indicates a perfect negative (inverse) correlation, and a value close to zero indicates a very weak correlation, which may, according to a threshold, may be deemed to indicate no correlation.

In the example of FIG. 9, the GUI 900 may be generated and rendered to indicate how variables (e.g., types of logs) correlate or not (e.g., though use of PCA as a choice of model). The results in FIG. 9 show that the combination model possesses an acceptable ability to discriminate between “good” and “bad” versions of combinations of bulk density, compressional slowness, and neutron porosity, but less discrimination power for gamma ray. While gamma ray provides some amount of correlation, its ability to discriminate is not as good as the other variables in the example of FIG. 9.

As an example, a method may utilize results such as those in the example of FIG. 9 to adjust or otherwise select types of logs to be utilized in combinations. For example, consider dropping gamma ray from a group such that the group is redefined as bulk density, compressional slowness, and neutron porosity.

While the example in FIG. 9 concerns rock related logs, consider a scenario where drilling related logs may be assessed. In such a scenario, a variable such as standpipe pressure (SPP or SPPA) may be substantially orthogonal to one or more other drilling related variables as fluid pressure in a standpipe of a drilling rig may be relatively unrelated to other variables that more directly characterize interactions between a drill bit and a formation (e.g., rock). In drilling, a metric known as mechanical specific energy (MSE) may be utilized to represent drilling efficiency. MSE may be defined as energy required to remove a unit volume of rock. In various instances, for optimal drilling efficiency, a driller (e.g., human and/or machine) may aim to minimize MSE and to maximize rate of penetration (ROP), for example, by controlling one or more of weight on bit (WOB), torque, ROP, and drill bit revolutions per minute (RPM). Hence, ROP, WOB, torque (e.g., TQA), RPM, and energy may be expected to exhibit some amount of correlation (e.g., cross-correlation).

As shown in the example of FIG. 9, component values may be plotted using a correlation circle (e.g., a variables factor map). While a single plot is shown, more than one plot may be generated and or shown (e.g., as may be for a factorial plane that may be a vector space made up of the intersection of two of the principal components).

Table 2, below, provides some processing conditions or processing concerns and indications as to acceptability and some examples of reasons why or why not.

TABLE 2
Example Processing Conditions or Concerns.

| Processing Condition | Acceptable | Why |
|---|---|---|
| Discard log versions with | Yes | Constant readings may |
| first/last reading within | | create a model that has |
| zone of interest | | less predictive power |
| Discard bulk density | Yes | Erroneous bulk density |
| versions where washout | | measurements in washed |
| has not been | | out zones may create a |
| reconstructed within a | | model that has less |
| zone of interest | | predictive power |
| Rank sets of triple/quad | Yes | If one of the triple/quad |
| combination versions that | | combo input candidates is |
| are consistently depth | | not depth shifted |
| shifted | | consistently with the other |
| | | measurements, the model |
| | | may be inconsistent |
| Rank versions of | No | Sensitivity of a model to |
| resistivity logs that have | | resistivity logs may be |
| been corrected | | very low, making the |
| | | model unable to properly |
| | | discriminate versions of |
| | | resistivity logs |
| Identify sets of quad | No | Model may check whether |
| combination versions that | | logs are consistently |
| are at the proper depth | | depth shifted with each |
| | | other; however, unable to |
| | | identify which is the |
| | | correct depth reference |
| Identify best version of | No | Absolute values of |
| logs that do not directly | | Caliper, Bulk Density |
| characterize rock | | Correction do not directly |
| | | characterize rock; model |
| | | unable to properly |
| | | discriminate between |
| | | versions of such |
| | | measurements |
| Identify versions of | Yes | Environmentally corrected |
| Neutron Porosity and Bulk | | versions of logs allow the |
| Density that have been | | model to better |
| environmentally corrected | | characterize petrophysical |
| | | properties |

As to an ML model, consider a framework that can implement a relatively lightweight ML model such as logistic regression (LR). LR is a type of statistical model (e.g., also known as logit model) that may be used for classification and predictive analytics. LR estimates the probability of an event occurring, such as voted or didn't vote, based on a given dataset of independent variables. As the outcome is a probability, the dependent variable can be bounded between 0 and 1. In logistic regression, a logit transformation can be applied on the odds—that is, the probability of success divided by the probability of failure.

As mentioned, LR can be utilized for classification. As an example, a framework may implement a LR classifier. For example, consider the scikit-learn LR classifier, also known as logit and maximum entropy classification (MaxEnt) (see, e.g., sklearn.linear_model. LogisticRegression). In a multiclass case, a training algorithm can use the one-vs-rest (OvR) scheme if the ‘multi_class’ option is set to ‘ovr’, and uses the cross-entropy loss if the ‘multi_class’ option is set to ‘multinomial’; noting that ‘multinomial’ option is supported by the ‘lbfgs’, ‘sag’, ‘saga’ and ‘newton-cg’ solvers. In the scikit-learn framework, the LR class implements regularized logistic regression using the ‘liblinear’ library, ‘newton-cg’, ‘sag’, ‘saga’ and ‘lbfgs’ solvers. Note that regularization is applied by default. It can handle both dense and sparse input. An implementation may use C-ordered arrays or CSR matrices containing 64-bit floats for optimal performance; noting that other input format can be converted (and copied). In the scikit-learn framework, the ‘newton-cg’, ‘sag’, and ‘lbfgs’ solvers support L2 regularization with primal formulation, or no regularization. The ‘liblinear’ solver supports both L1 and L2 regularization, with a dual formulation only for the L2 penalty. The Elastic-Net regularization is supported by the ‘saga’ solver.

In the scikit-learn framework LR is implemented as a linear model for classification rather than regression in terms of the scikit-learn/ML nomenclature. The logistic regression is also known in the literature as logit regression, maximum-entropy classification (MaxEnt) or the log-linear classifier. In this model, the probabilities describing the possible outcomes of a single trial are modeled using a logistic function. As explained, the scikit-learn implementation of LR can fit binary, one-vs-rest, or multinomial logistic regression with optional, or Elastic-Net regularization. Regularization is applied by default, which is common in machine learning but not in statistics. Another advantage of regularization is that it improves numerical stability. No regularization amounts to setting the parameter C to a very high value. LR is a special case of the Generalized Linear Models (GLM) with a binomial/Bernoulli conditional distribution and a logit link. The numerical output of the logistic regression, which is the predicted probability, can be used as a classifier by applying a threshold (by default 0.5) to it. This is how it may be implemented in scikit-learn, such that it expects a categorical target, making the LR method a classifier.

As an example, LR can be implemented using an input dataset to create a predictive model of an outcome variable. For example, consider an input dataset of log data for one or more types of logs that can create a predictive model of an outcome variable that can be for a different type of log. As an example, LR can be implemented in a multinomial manner. Multinomial LR can be implemented as a classification technique that generalizes logistic regression to multiclass problems (e.g., with more than two possible discrete outcomes). For example, consider a model that can be used to predict probabilities of different possible outcomes of a categorically distributed dependent variable, given a set of independent variables (e.g., real-valued, binary-valued, categorical-valued, etc.). As an example, the scikit learn framework can implement multiclass prediction. For example, for a multi_class problem, if multi_class is set to be “multinomial” the softmax function is used to find the predicted probability of each class; otherwise, a one-vs-rest (OVR) approach can be utilized (e.g., calculate the probability of each class assuming it to be positive using the logistic function and normalize these values across all the classes).

As explained, the number of permutations may be quite large. As an example, consider over 1 million permutations to be assessed. As to an example of an equation that demonstrates how the number of permutations can increase, for a more general case, consider the following equation:

$${P}_{k}^{n} = \frac{n !}{( n - k ) !}$$

where n is the total number of objects and k is the number of objects selected (e.g., a k-element subset of an n-set).

To make a framework practical in performing such assessments, the LR model can be implemented, which can be considered a relatively lightweight model. As an example, a framework can include learning on a portion of data and performing a blind test on another portion of the data to assess how well the model can predict. As explained, a score can be generated as an indicator of how well a model is working (e.g., its ability to predict). As explained, a physical system can tie logs together such that some amount of meaningful correlation can be expected for at least some realizations (e.g., permutations). As explained, LR can be implemented as an ML model that is relatively fast, computationally, to determine if various logs can build an acceptable model where the LR approach is applied to entries of the permutation matrix.

As an example, a workflow can provide for identifying a best entry in a permutation matrix as to log predictability and then persist that entry (e.g., log permutation) for one or more purposes, which can include, for example, applying the permutation, if suitable, to one or more additional formation types. As an example, a workflow may operate relatively independently on formation type by formation type such that a best entry differs between at least two different formation types. For example, one permutation may be the best for one formation type while a different permutation may be the best for another formation type.

As explained, logs may be selected with respect to a type of formation, which may be in a field (e.g., a basin) where many wells have been drilled; thus, logs can exist for multiple wells where the logs include log data that corresponds to one or more types of formations. And, as explained, log data may be altered, for example, via adjustments that may occur during one or more workflows; hence, for an original log, there may be multiple versions of that original log stored in a data store. As mentioned, a permutation matrix can include hundreds of entries, thousands of entries, tens of thousands of entries, hundreds of thousands of entries to more than one million entries. Thus, to assess entries in a permutation matrix, a framework can provide for implementing one or more relatively lightweight techniques to expedite scoring. In various examples, a job or project may include assessing logs for more than one type of formation where a permutation matrix exists for each type of formation.

As explained, a framework can provide a score for a number of entries in a permutation matrix (see, e.g., the scenarios in Table 1), which may be an entire number of entries. Such a score can indicate how well a model is working, for example, how well logs utilized to learn are correlated. As explained, an ML model can be trained using a portion of log data and then be tested using another portion of the log data. A framework can include features to access one or more types of models where, for example, a model library can include a logistic regression model, which may include various model parameters that can be suitably selected. As to drilling logs, the number of types of logs may be relatively limited when compared to the number of types of petrophysical logs. For example, drilling log types may be approximately 20 or less; whereas, petrophysical log types may be greater, which may be greater than 30, 40, 50, 100, etc.

Output from a framework may be utilized for one or more purposes. For example, consider using output for interpretation, machine learning, control, etc. As mentioned, logs can include petrophysical logs and/or drilling logs. As to control of drilling, consider using output for determining one or more parameters for drilling in a particular type of formation where the drilling can be for a new well in a field where the output of the framework can be based on offset wells in the field.

As an example, output of a framework can be a best set of measurements to be used for drilling. In such an example, consider measurements that suitably relate RPM to ROP where the RPM measurements may be utilized in drilling into a type of formation to provide a desirable ROP (e.g., a desirable, expected ROP). As explained, a physical system can include drilling equipment and formation to be drilled. Hence, where RPM log data relates to observed ROP log data, RPM can be a predictor of ROP. While RPM is mentioned in the foregoing example, one or more other types of logs may be utilized, additionally or alternatively. In various instances, torque log data may be utilized, alone or in combination with one or more other types of log data, as torque can characterize a physical system that includes drilling equipment and formation to be drilled. As an example, a framework may assess log data to determine whether or not torque log data exist. In such an example, where torque log data are lacking, a series of logs may be excluded (e.g., as prediction of ROP can be challenging without knowledge of torque). An ROP prediction model without utilization of torque may be characterized by a low correlation score.

As an example, a method can provide for assessing log data in one or more data stores for one or more physical systems. In such an example, a framework can be provided access to the one or more data stores to determine what data therein are the best in terms of scenarios that can be defined in a permutation matrix. The output of the best log data can inform a data owner as to what data are suitable usable with some level of confidence and, for example, what data may be unsuitable for use, and, if desired, deleted from the one or more data stores. As an example, best log data may be sub-optimal for one or more purposes. In such an example, the best log data may be subjected to one or more processes to improve these data. For example, consider a human-in-the-loop (HITL) approach where identified best log data are subjected to HITL interpretation, which may provide for adjustments to at least a portion of the best log data. While a HITL approach is mentioned, one or more other approaches may be utilized, optionally machine-based and automatic. As an example, a framework can generate metrics, which can include best log data metrics and/or metrics for other log data. As an example, a framework can generate metrics as to duplicates, data genealogy, etc.

As an example, based on one or more metrics, data handling practices may be determined. For example, consider persisting of log data that may have been generated from suboptimal measurements. In such an example, one or more forensic techniques may be applied to identify how and/or why such a data handling practice occurred. In turn, one or more workflows can be revised, reformulated, etc. As an example, a framework may generate one or more family trees of log data as part of a data forensics feature. As an example, a framework may provide for determining which interpretations may have been made from subpar measurements. In such an example, where the framework identifies the best log data, one or more workflows (e.g., interpretation workflows) may be repeated using the best log data. As an example, improved interpretations may be propagated to other workflows to improve their outcomes, decision making, etc.

As an example, a framework can provide for a fieldwide assessment of log data for a field to determine whether suboptimal (e.g., subpar) log data have been utilized in one or more workflows, which may have a detrimental impact on decision making, field operations, etc. Such an approach may be utilized as a sanity check and/or for field optimization. For example, consider a field where production may be declining after a number of years in a manner that deviates from a predicted decline. In such an example, a framework can assess the underlying log data to determine whether or not the best log data were utilized and, as explained, optionally to identify where subpar log data were utilized and possibly propagated.

As an example, a framework may be scheduled to operate as part of a background process, which may be relatively continuous or periodic. For example, a field may be scheduled to be reassessed at three-year intervals. In such an example, prior to a reassessment, the framework may assess log data in one or more data stores for the field and generate output as to whether or not the best log data were utilized for a prior assessment and/or prior reassessment. In such an example, the framework may indicate what are the best log data for the reassessment such that the reassessment can be performed in a more accurate manner.

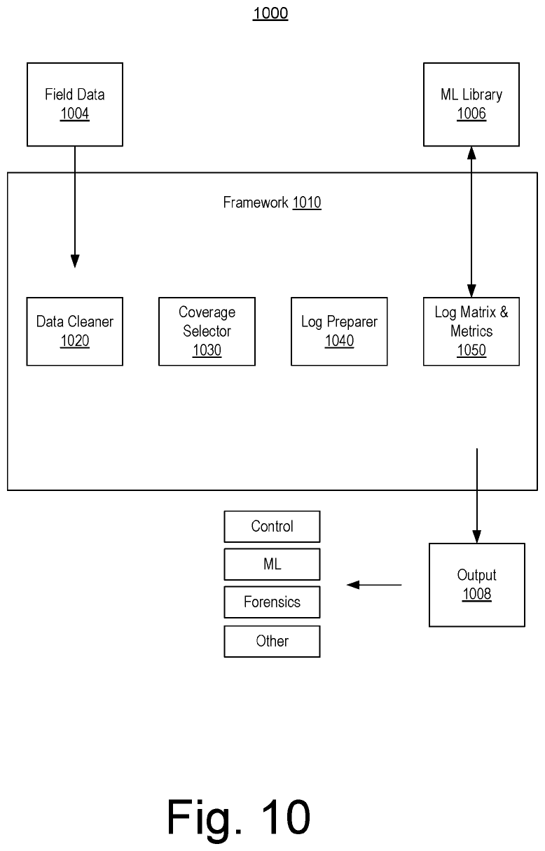

FIG. 10 shows an example of a framework 1010 that can access and assess field data 1004 to generate output 1008, which may be utilized for one or more purposes such as, for example, control, machine learning, forensics, etc. As shown in the example of FIG. 10, the framework 1010 can include a data cleaner component 1020, a coverage selector component 1030 (e.g., for ZOI, etc.), a log preparer component 1040 (e.g., to prepare logs for ML, etc.) and a log matrix and metrics component 1050. As shown, the log matrix and metrics component 1050 can be operatively coupled to one or more ML libraries 1006. For example, consider an ML library that includes one or more relatively lightweight ML models that can assess entries (e.g., scenarios, etc.) in a permutation matrix. As explained, a logistic regression (LR) model may be utilized to provide for scores as a type of metric. As explained, scores may be utilized in ranking to determine the best log data (e.g., field data) that exists in one or more data stores. As an example, a framework may provide for archiving, compressing, tagging, deleting, etc., data that may be considered poorly ranked (e.g., to conserve space, time as to future data projects, etc.).

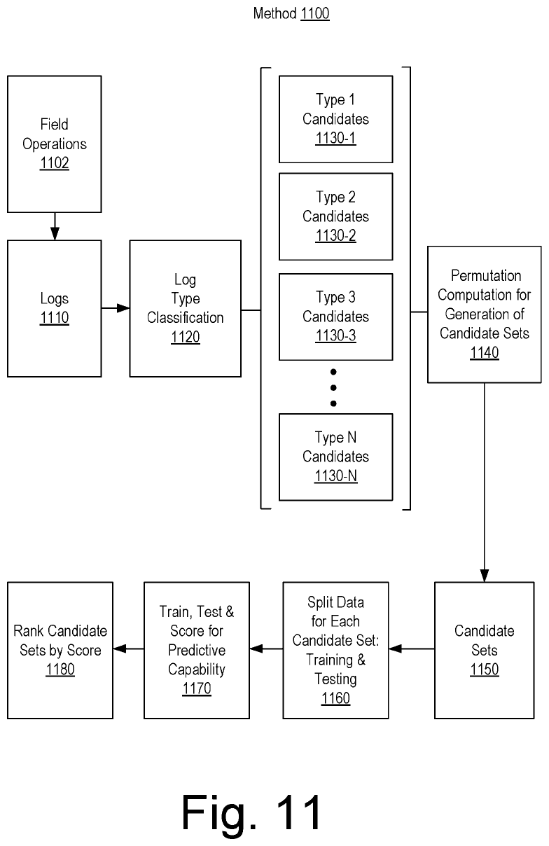

FIG. 11 shows an example of a method 1100 that includes performing field operations 1102 where logs 1110 are generated during the performance of the field operations (e.g., wireline, drilling, etc.). In such an example, the field operations 1102 may be numerous and may be performed over some period of time, which may be weeks, months, years, etc. As an example, the logs 1110 may be stored in one or more databases, which may be public, private, etc. As an example, a database may be a service provider database, a well operator database, etc. In various instances, a service provider may be called upon by a well operator to perform field operations that may involve logging that generates logs. Such logging may aim to solve a particular issue that may be germane to development of a well, production of a well, etc. Once the issue has been addressed, the logs may be stored to one or more databases, for example, to be archived as the particular issue has been addressed such that the service provider moves along to one or more other customers to address their issues. In such an approach, the logs may simply sit idle without being used for any particular purpose. Overtime, the number of such idle logs may increase substantially. In various instances, for a single field that includes hundreds or thousands of wells, the number of logs may be immense. However, gaining value from these logs may be a relatively insurmountable task, particularly with respect to time and/or resources for review, quality control, alignment, unit conversions, etc.

As explained, a framework such as, for example, the framework 1010 may provide for extracting logs that are not, at some level, inconsistent. As explained, correlation in a broad sense is a measure of an association between variables. As explained, certain variables may be expected to have some association with one another and therefore be deemed consistent or, at some level, not inconsistent. For example, density, gamma, and sonic logs in the example of FIG. 8 may be expected to be consistent such that within a set of such logs, when considered in different combinations, logs that fail to adequately provide predictive power may be deemed inconsistent. Such inconsistent logs may be deemed problematic (e.g., low quality, etc.) and therefore may be excluded from other logs that do provide adequate predictive power. In such an approach, logs may be effectively classified with respect to predictive power as an indicator of consistency or, stated otherwise, an indicator of not being inconsistent (e.g., as may be determined relatively, numerically, via one or more criteria, etc.).

Referring again to the logs 1110 in FIG. 11, a framework may be able to filter through such logs, which may number in the thousands, tens of thousands, or more, and readily identify logs that are sufficiently consistent (or sufficiently not inconsistent) such that those identified logs may be utilized for one or more purposes. In such an approach, a framework may help to extract value from logs that may otherwise sit idly in one or more databases. As explained, logging may be an involved process that expends time and resources such that logs generated from such logging may be considered to be expensive to acquire. As an example, a framework may be implemented to help extract value from such expenditures.

As shown in the method 1100 of FIG. 11, the logs 1110 may be subject to a log type classification process. For example, consider a process that may access individual logs and determine what types of logs may be within a log chart. In some instances, a log chart may include one log whereas in other instances a log chart may include more than one log. As shown in FIG. 11, the logs 1110 may be split out into various types, which may be deemed to be candidate types 1130-1, 1130-2, 1130-3, . . . , 1130-N. For example, once the types of logs are known, the method 1100 may consider a threshold as a cutoff as to types for purposes of further assessment. For example, if one type of log is infrequent compared to various other types, that type may be excluded from being a candidate type as it may drive some limitations within generation of permutations (e.g., candidate sets).

As an example, a method may consider a depth or depth range, which may depend on information such as formation tops and/or other markers as to where one or more types of formations may be located in a subsurface environment. For example, logs may be assessed with respect to depths (e.g., one or more zones of interest, etc.) that correspond to known depths or expected depths of a type of rock, etc. Where a layer of rock may be dipping within a field, the depths of the boundaries of that layer of rock may vary spatially, which may depend on surface locations, etc. (e.g., consider surface x and y or latitude and longitude, etc.).

As shown in the method 1100, a permutation computation process 1140 can provide for generation of candidate sets 1150, which may be referred to as permutations. For example, where candidate types include gamma ray, density, neutron porosity, compressional slowness, and shear slowness, each candidate type may include, for example, ten or more individual candidates of that candidate type; noting that the number of individual candidates of various candidate types may number to one hundred or more. As may be appreciated, the number of permutations can become quite large (see also, e.g., Table 1). As such, a machine learning approach that may be relatively rapid (e.g., light-weight, relatively low computational and/or memory demands, etc.) may be implemented as each individual candidate set is to be utilized for machine learning training, testing and scoring.

As shown in the method 1100, data for each candidate set can be split for training and testing 1160 where such split data may be utilized to train, test and score predictive capability 1170 for each candidate set. As shown, the candidate sets may be ranked 1180 by their scores as to predictivity capability.

As explained, a framework may provide for filtering logs such that logs that do not provide for adequate predictive capability are deemed as being to some level inconsistent. As an example, candidate sets that are ranked poorly may be assessed to determine whether one or more particular logs commonly appear in those candidate sets. Logs that may commonly appear in poorly ranked candidate sets may be deemed inconsistent or detrimental to predictive power when set forth in various permutations (e.g., candidate sets).

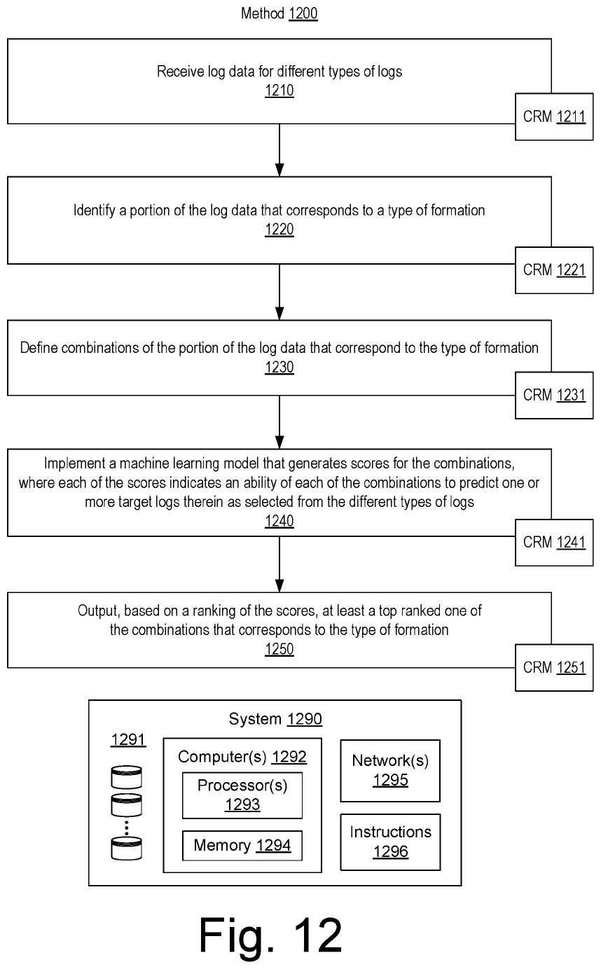

FIG. 12 shows an example of a method 1200 and an example of a system 1290. As shown, the method 1200 can include a reception block 1210 for receiving log data for different types of logs; an identification block 1220 for identifying a portion of the log data that corresponds to a type of formation; a definition block 1230 for defining combinations of the portion of the log data that correspond to the type of formation; an implementation block 1240 for implementing a machine learning model that generates scores for the combinations, where each of the scores indicates an ability of each of the combinations to predict one or more target logs therein as selected from the different types of logs; and an output block 1250 for outputting, based on a ranking of the scores, at least a top ranked one of the combinations that corresponds to the type of formation. As an example, the method 1200 of FIG. 12 may be implemented at least in part using a framework such as, for example, the framework 1000 of FIG. 10.

The method 1200 is shown in FIG. 12 in association with various computer-readable media (CRM) blocks 1211, 1221, 1231, 1241 and 1251. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 1200. As an example, a computer-readable medium (CRM) may be a computer-readable storage medium that is non-transitory and that is not a carrier wave. As an example, one or more of the blocks 1211, 1221, 1231, 1241 and 1251 may be in the form processor-executable instructions.

In the example of FIG. 12, the system 1290 includes one or more information storage devices 1291, one or more computers 1292, one or more networks 1295 and instructions 1296. As to the one or more computers 1292, each computer may include one or more processors (e.g., or processing cores) 1293 and memory 1294 for storing the instructions 1296, for example, executable by at least one of the one or more processors 1293 (see, e.g., the blocks 1211, 1221, 1231, 1241 and 1251). As an example, a computer may include one or more network interfaces (e.g., wired or wireless), one or more graphics cards, a display interface (e.g., wired or wireless), etc.

As explained, a framework enables effectively filtering massive amounts of job data, which may be or include log data. In various instances, a service provider may be called in on an urgent matter, expeditiously perform the job and solve the problem, and then later concern itself with learning from the data (e.g., time permitting). As the number of jobs stack-up, are performed, etc., the amount of data can build, making the task to sort through the data and learn therefrom more arduous. As explained, a framework enables sorting through data to find data sets that are not inconsistent (e.g., at some level according to one or more criteria). As explained, a framework may be applied to data such as log data, which may be for formations (e.g., rocks) and/or drilling operations.

As an example, a framework enables improved planning for drilling operations. For example, consider a field where wells have been drilled and logs acquired. In planning for a new well or additional operations for an existing well, a framework may access logs and effectively filter through the logs to identify sets of logs that may be useful to improve planning. For example, consider identifying sets of logs that may be useful in more accurately identifying one or more types of formations, formation boundaries, etc., at a new well location (e.g., as to a borehole trajectory for a new well at that location). As an example, where identified sets of logs pertain to drilling operations variables, the logs may be utilized in planning drilling operations. For example, consider extracting drilling operations variables from an identified set or sets of logs where such drilling operations variables may be utilized in a digital drill plan that may provide for automated and/or semi-automated drilling of a new well (e.g., or additional drilling of an existing well, etc.). For example, consider an autodriller as a type of controller that can be programmed using information contained in one or more identified sets of logs for drilling operations variables. In such an example, the autodriller may aim to drill more optimally, for example, with reduced MSE and increased ROP.

As to some types of machine learning models that may be implemented for one or more purposes, consider, for example, one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis (PCA), partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn framework), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train an ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). TFL offers multiple platform support, covering ANDROID and iOS devices, embedded LINUX, and microcontrollers. TFL offers diverse language support, which includes JAVA, SWIFT, Objective-C, C++, and PYTHON. TFL offers high performance, with hardware acceleration and model optimization.

As an example, a TFL or other lightweight framework approach may be implemented in the field, optionally within a downhole tool string that can execute framework processes downhole, which may provide for real-time decision making, control, etc.

As an example, a method can include receiving log data for different types of logs; identifying a portion of the log data that corresponds to a type of formation; defining combinations of the portion of the log data that correspond to the type of formation; implementing a machine learning model that generates scores for the combinations, where each of the scores indicates an ability of each of the combinations to predict one or more target logs therein as selected from the different types of logs; and outputting, based on a ranking of the scores, at least a top ranked one of the combinations that corresponds to the type of formation. In such an example, the machine learning model can be or include a logistic regression model.

As explained, a target log may be selected from amongst logs in a set (e.g., a candidate set, which may be referred to as a permutation or a combination), where that target log may provide for assessing predictability as a proxy for correlation (e.g., or consistency or not being inconsistent). Once assessed, a model that has some demonstrated ability to predict that target log may be of value or not. As explained, an aim may not be to generate predictive models for further use thereof, rather an aim may be to generate predictive models as a means to assess consistency amongst a set of logs, or a lack thereof. As explained, a density may be utilized as a target for formation related logs, rate of penetration (ROP) may be utilized as a target for drilling operations related logs, one or more targets may be utilized, etc. As explained, selection of a target or targets for prediction can provide for an assessment of consistency amongst a set of logs (e.g., a combination or permutation).

As explained, a type of formation may correspond to a particular depth or depths in a subsurface environment. For example, where logs pertain to physical characteristics of rock, the logs may be assessed with respect to a particular layer of rock, which may be defined by one or more boundaries (e.g., interfaces, etc.). As an example, where logs pertain to drilling operations, drilling operations variables may be set or adjusted to drill into and/or through a type of formation. For example, drilling operations variables for drilling into one type of rock may be expected to differ from one or more of those for drilling into another type of rock. In various examples, within a formation, drilling operations variables may be set or adjusted with respect to depth (e.g., measured depth, etc.). As an example, a type of formation may be a proxy for depth such that identifying a portion of log data that corresponds to a type of formation may provide for identifying that portion as corresponding to depth (e.g., a particular depth range, etc.).

As an example, defining combinations can include defining a permutation matrix. For example, consider a permutation matrix that includes a dimension for the combinations (e.g., scenarios) and a dimension for the different types of logs. As explained, a combination may be referred to as a permutation or a candidate set (e.g., a set of candidates that are logs of different log types, etc.).

As an example, log data can include different sets of log data for one or more of different types of logs. As an example, log data can include petrophysical log data and/or drilling operations log data. As an example, drilling operations log data can include at least torque data.

As an example, one or more target logs can include a density log. As an example, one or more target logs can include a rate of penetration log.

As an example, log data can characterize a physical system. For example, consider a physical system that includes one or more types of formations and one or more emission energies of one or more types of logging sensors and/or a physical system that includes one or more types of formations and at least a drill bit coupled to a drillstring.

As an example, different types of logs can include more than five different types of logs. As an example, combinations can include more than one hundred combinations.

As an example, log data can include multi-well log data. For example, consider multi-well log data are from more than five wells. As an example, log data can include versions of log data. For example, consider a family tree of log data where an original version is altered via one or more generations of alterations. As an example, a method may provide for assessing one or more sets of log data that may be part of a family tree of log data.

As an example, a method can include, based at least in part on a top ranked combination, performing one or more of control of field equipment, machine learning, and data management. As an example, data management can include data forensics. As an example, data forensics may provide a basis for workflow assessment, which can include workflow revision.

As an example, a system can include one or more processors; memory accessible to at least one of the one or more processors; processor-executable instructions stored in the memory and executable to instruct the system to: receive log data for different types of logs; identify a portion of the log data that corresponds to a type of formation; define combinations of the portion of the log data that correspond to the type of formation; implement a machine learning model that generates scores for the combinations, where each of the scores indicates an ability of each of the combinations to predict one or more target logs therein as selected from the different types of logs; and output, based on a ranking of the scores, at least a top ranked one of the combinations that corresponds to the type of formation. As an example, one or more computer-readable storage media can include processor-executable instructions to instruct a computing system to: receive log data for different types of logs; identify a portion of the log data that corresponds to a type of formation; define combinations of the portion of the log data that correspond to the type of formation; implement a machine learning model that generates scores for the combinations, where each of the scores indicates an ability of each of the combinations to predict one or more target logs therein as selected from the different types of logs; and output, based on a ranking of the scores, at least a top ranked one of the combinations that corresponds to the type of formation.

As an example, a computer program product can include one or more computer-readable storage media that can include processor-executable instructions to instruct a computing system to perform one or more methods and/or one or more portions of a method.

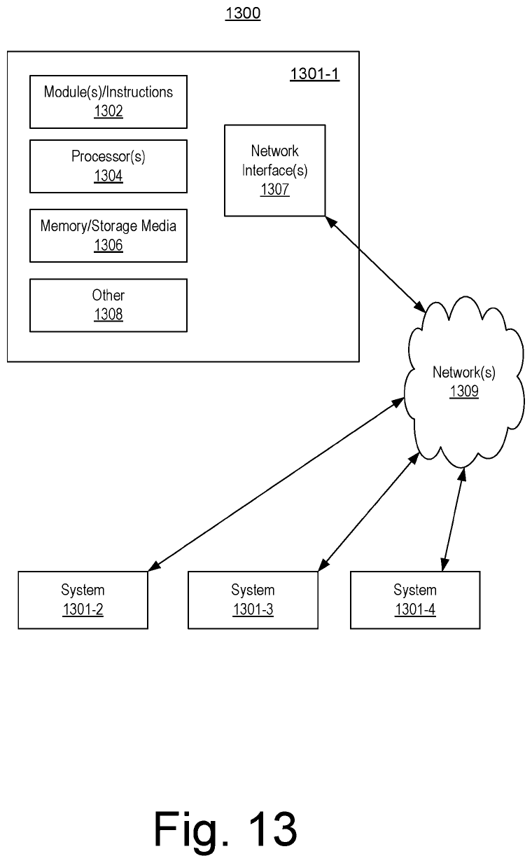

In some embodiments, a method or methods may be executed by a computing system. FIG. 13 shows an example of a system 1300 that can include one or more computing systems 1301-1, 1301-2, 1301-3 and 1301-4, which may be operatively coupled via one or more networks 1309, which may include wired and/or wireless networks. As shown, the system 1300 may include one or more other components 1308.

As an example, a system can include an individual computer system or an arrangement of distributed computer systems. In the example of FIG. 13, the computer system 1301-1 can include one or more modules 1302, which may be or include processor-executable instructions, for example, executable to perform various tasks (e.g., receiving information, requesting information, processing information, simulation, outputting information, etc.).

As an example, a module may be executed independently, or in coordination with, one or more processors 1304, which is (or are) operatively coupled to one or more storage media 1306 (e.g., via wire, wirelessly, etc.). As an example, one or more of the one or more processors 1304 can be operatively coupled to at least one of one or more network interfaces 1307; noting that one or more other components 1308 may also be included. In such an example, the computer system 1301-1 can transmit and/or receive information, for example, via the one or more networks 1309 (e.g., consider one or more of the Internet, a private network, a cellular network, a satellite network, etc.).

As an example, the computer system 1301-1 may receive from and/or transmit information to one or more other devices, which may be or include, for example, one or more of the computer systems 1301-2, etc. A device may be located in a physical location that differs from that of the computer system 1301-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1306 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution. As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving log data for different types of logs;
identifying a portion of the log data that corresponds to a type of formation;
defining combinations of the portion of the log data that correspond to the type of formation;
implementing a machine learning model that generates scores for the combinations, wherein each of the scores indicates an ability of each of the combinations to predict one or more target logs therein as selected from the different types of logs; and
outputting, based on a ranking of the scores, at least a top ranked one of the combinations that corresponds to the type of formation.

2. The method of claim 1, wherein the machine learning model comprises a logistic regression model.

3. The method of claim 1, wherein defining the combinations comprises defining a permutation matrix.

4. The method of claim 3, wherein the permutation matrix comprises a dimension for the combinations and a dimension for the different types of logs.

5. The method of claim 1, wherein the log data comprise different sets of log data for one or more of the different types of logs.

6. The method of claim 1, wherein the log data comprise petrophysical log data.

7. The method of claim 1, wherein the log data comprise drilling operations log data.

8. The method of claim 7, wherein the drilling operations log data comprise at least torque data.

9. The method of claim 1, wherein the one or more target logs comprises a density log.

10. The method of claim 1, wherein the one or more target logs comprises a rate of penetration log.

11. The method of claim 1, wherein the log data characterize a physical system.

12. The method of claim 11, wherein the physical system comprises one or more types of formations and one or more emission energies of one or more types of logging sensors.

13. The method of claim 11, wherein the physical system comprises one or more types of formations and at least a drill bit coupled to a drillstring.

14. The method of claim 1, wherein the different types of logs comprise more than five different types of logs.

15. The method of claim 1, wherein the combinations comprise more than one hundred combinations.

16. The method of claim 1, wherein the log data comprise multi-well log data.

17. The method of claim 16, wherein the multi-well log data are from more than five wells.

18. The method of claim 1, comprising, based at least in part on the top ranked combination, performing one or more of control of field equipment, machine learning, and data management.

19. A system comprising:
one or more processors;
memory accessible to at least one of the one or more processors;
processor-executable instructions stored in the memory and executable to instruct the system to:
receive log data for different types of logs;
identify a portion of the log data that corresponds to a type of formation;
define combinations of the portion of the log data that correspond to the type of formation;
implement a machine learning model that generates scores for the combinations, wherein each of the scores indicates an ability of each of the combinations to predict one or more target logs therein as selected from the different types of logs; and
output, based on a ranking of the scores, at least a top ranked one of the combinations that corresponds to the type of formation.

20. One or more computer-readable storage media comprising processor-executable instructions to instruct a computing system to:
receive log data for different types of logs;
identify a portion of the log data that corresponds to a type of formation;
define combinations of the portion of the log data that correspond to the type of formation;
implement a machine learning model that generates scores for the combinations, wherein each of the scores indicates an ability of each of the combinations to predict one or more target logs therein as selected from the different types of logs; and
output, based on a ranking of the scores, at least a top ranked one of the combinations that corresponds to the type of formation.
